(19) United States
(12) Patent Application Publication
(10) Pub. No.: US 2023/0413795 A1
(43) Pub. Date: Dec. 28, 2023

(54) Fishing Lure with Changeable Direction

(71) Applicant: Levi Joseph Sanchez, Fountain Inn, SC (US)

(72) Inventor: Levi Joseph Sanchez, Fountain Inn, SC (US)

(21) Appl. No.: 17/816,816

(22) Filed: Aug. 2, 2022

Related U.S. Application Data
(60) Provisional application No. 63/228,713, filed on Aug. 3, 2021.

(51) Int. Cl. A01K 85/00

(52) U.S. Cl. CPC A01K 85/1863

(57) ABSTRACT

A steerable top water fishing lure featuring a line attachment point located ⅙^{th} to ½ of the total length of the lure from the top of the lure. The line attachment point is located on a frontal plane which is wider than the depth of the body of the lure. The Fishing lure is also buoyant and features a center of gravity located between ⅓^{rd} and ¾ of the length of the total lure from the top of the lure as well as a propeller/tail/blade attached to the body. The combination of these features allows this lure when cast to travel on its side laterally from the direction of shortest travel back to the angler. Due to the lures design, when the lure is twitched/pulled sharply, the force of the twitch will cause the lure to overcome the force of the water on the frontal plane of the lure. This imbalance of force causes the top of the body to exit the surface of the water and invert facing the opposing direction. When the body of the lure lands on the surface of the water, the previous side which was oriented down will be oriented up and the side which was oriented up will be oriented down. Because the lure has inverted and is now riding on its opposing side it will start to travel the opposite direction until twitched again or the retrieve is stopped. This action allows for the angler to steer this lure around cover where other lures cannot go, while never submerging where the lure could potentially get snagged.

### TECHNICAL FIELD

The present invention relates generally to fishing lures, and more particularly, to a buoyant top water fishing lure with a defined top and bottom featuring a propeller/tail/blade as well as a non-moving line attachment point located on the frontal plane. This point and frontal plane in relation to the depth of the body and center of gravity allows the lure to travel laterally to the line of shortest travel back to the angler and will invert and travel the opposite direction when twitched. This inversion on the surface of the water allows the angler to steer the lure around cover and structure.

### BACKGROUND

Top water fishing lures are a common type of fishing lure favored by many anglers. The term “top water” generally refers to any fishing lure that is retrieved on the surface of the water. These top water fishing lures generally cause a disturbance on the surface of the water which often attracts fish into attacking the lure. To greater the chances of catching fish, anglers often cast these lures near areas that they believe to have fish.

While fish obviously need to feed to survive, they also need shelter (commonly referred to as “cover/structure”). Many anglers know that to find fish you need to find two things: food and cover. Because fish often hide in cover, anglers must cast their lures into and around the cover to present their lures to fish. This creates an issue since casting into and around cover can often lead to the lure getting snagged. To unsnag the lure, the angler often must either risk scaring the fish away or risk losing their bait. My invention is a steerable top water fishing lure featuring a line attachment point located ⅙^{th} to ½ of the total length of the lure from the top of the lure. The line attachment point is located on a frontal plane which is wider than the depth of the body of the lure. The Fishing lure is also buoyant and features a center of gravity located between ⅓^{rd} and ¾ of the length of the total lure from the top of the lure. The combination of these features allows this lure when cast to travel on its side laterally from the direction of shortest travel back to the angler. Due to the lures design, when the lure is twitched/pulled sharply the force of the twitch will cause the lure to overcome the force of the water on the frontal plane of the lure. This imbalance of force causes the top of the body to exit the surface of the water and invert facing the opposing direction. When the body of the lure lands on the surface of the water, the previous side which was oriented down will be oriented up and the side which was oriented up will be oriented down. Because the lure has inverted and is now riding on its opposing side it will start to travel the opposite direction until twitched again or the retrieve is stopped. Because my invention travels laterally to the line of shortest travel back to the angler, anglers can use this lure to steer into and around cover without getting snagged. Instead of risking casting the lure into the cover where the said lure could become snagged, the angler can cast the lure a comfortable distance away from the cover and steer the lure near the cover as well as around the cover and potential snags. This allows anglers to present their lure to fish in cover/structure while greatly reducing their risk of getting snagged and scaring the fish or losing their lure.

Often when fish attack top water fishing lures it is merely a reaction bite. Because of this, wary fish will often follow a bait but not bite because nothing is done to trigger a reaction from the fish. While a handful of people have tried to make a steerable top water bait to trigger a reaction, none of them have done it such that the change of direction is realistic.

One example is the lure defined in patent U.S. Pat. No. 7,162,829 B2. The previous lure defined in patent U.S. Pat. No. 7,162,829 B2 does not have a defined top and bottom and features a moveable, non-permanent line attachment point, as well as a concave frontal plane. When the lure is twitched, instead of turning over and heading the opposite direction, it travels “backwards.” This motion is unnatural as fish often do not swim backwards to flee, and can fail to trigger the fish into biting. My invention is different because it features a permanent line tie as well as a propeller/tail/blade and a does not feature a concave frontal plane. These different characteristics allows my invention to turn over on the top of the water whereas the other lure does not invert. The ability to turn over on the top of the water and then track laterally the other direction is very realistic as it mimics a baitfish trying to jump from the water and swim away.

Another similar but vastly different fishing lure is the “triggerfish” created by ThinkTankLures. This lure features a heavily weighted jointed head located at the top of the bait as well as a large bill/lip extending from the back of the lure. The triggerfish features a very deep body with a very narrow width. This lure changes direction by allowing the weighted head to sink into the water. When pulled, the lure will swim underwater in a wide circle and when it completes its circle it will travel the other direction on the surface of the water. The issue with this design is that for the lure to turn it must swim down into the water. Bait fish rarely swim back down towards the fish which is following them. This creates an unnatural action which can often cause the fish to not attack the lure. On the other hand, my invention features a body which is wider than it is deep and features a taper to a point which is offset towards the back. This taper eliminates the need for a lip/bill and makes the lure more streamlined. My invention is different because the frontal plane is wider than the bait is deep, and the front tapers to a point which is offset towards the back. These two features, along with the location of the line tie, the buoyance of the body, and a prop/tail/blade allows my lure to turn over on the surface of the water instead of diving into the water. This action is similar to a baitfish trying to jump to flee from the chasing fish which creates a much more realistic presentation, greatly increasing the chances of persuading the fish to strike.

The last lure to feature a lateral path of travel is the lure referred to in patent U.S. Pat. No. 6,173,522. This lure accomplishes a lateral path of travel by using a buoyant body and a concave front plane with a body profile including a surface tapering inwardly from the head rearwardly along the body. Distinctly different, my invention features a frontal plane which is not concave and a body which is wider than it is deep. Also, my invention features a propeller/tail/blade paired with an offset line tie in which the previous lure does not include. The addition of a propeller/tail/blade helps to make noise and extra movement which can often trigger fish into striking. Other lures do not include a propeller/tail/blade because the force from the propeller/tail/blade often causes the lure to run incorrectly. The addition of an offset line tie from right to left compensates for the force from the propeller/tail/blade and allows the lure to run correctly. The combination of a frontal plane which is wider than the depth, the addition of a propeller/tail/blade, and an offset line tie allows my invention to invert on the surface of the water and run laterally while also having the benefits of a propeller/tail/blade. These characteristics also allow the angler to steer the lure around cover instead of only traveling one direction. If you can only travel in one direction, you have no ability to avoid potential snags.

### BRIEF DESCRIPTION OF THE DRAWINGS

FIG. 1 shows the body of the lure with a permanent line attachment point (also known as a line tie) in an orthographic position.

FIG. 2A shows the body of the lure in an orthographic view as it defines the front, top, left, and right planes of the lure.

FIG. 2B shows the body of the lure from the side portraying the right side of the body of the lure to further clarify the location of the front, back, left, right, top and bottom of the lure.

FIG. 2C shows the body of the lure in an orthographic view. This view defines the location of the bottom of the lure.

FIG. 3A shows the depth of the body of the lure measuring from the front of the body to the base. The line tie is not included in this measurement as it is measuring the depth of the body of the lure and not the depth of the lure in relation to the line tie.

FIG. 3B shows the width of the body of the lure measuring from the right side/plane to the left side/plane.

FIG. 4A shows the total length of the lure body measured from top to bottom.

FIG. 4B shows the total length of the lure with a propeller/tail/blade measured from top to bottom. The propeller/tail/blade is included in the total length of the lure.

FIG. 5A shows the lure from a top view with a propeller/tail/blade as well as an offset line tie.

FIG. 5B shows the location of the center of gravity of the entire lure from the side. The location of the center of gravity is measured in relation to the total length of the lure. The center of gravity falls within ⅓^{rd} and ¾^{th} of the total length of the lure from the top of the lure.

FIG. 5C shows the lure in an orthographic view.

FIG. 5D shows the location of the center of gravity of the lure.

FIG. 6A shows the lure from a top view with a propeller/tail/blade as well as an offset line tie.

FIG. 6B shows the location of the permanent line attachment point from the side. The location of the line tie is measured in relation to the total length of the lure. The line tie falls within ⅙^{th} and ½ of the total length of the lure from the top of the lure.

FIG. 6C shows the lure in an orthographic view.

FIG. 6D shows line attachment point/line tie in relation to the total lure.

FIG. 7A shows the initial placement after casting the lure. The location shown in this view shows the location where the lure has first landed after being cast but before being retrieved. When the lure starts to be retrieved, it will turn over onto its right side and travel laterally from the line directly to the angler. It will continue to travel that direction until twitched or the retrieve stops.

FIG. 7B shows the location the lure is twitched which causes the lure to overcome the force of the water acting on it and flip along the surface and land with the opposite side (left side) in the water and the previous side (right side) facing up. During the flip, the top of the lure leaves the water while the bottom of the lure stays in the water. The lure pivots about the bottom of the lure. This inversion of the lure causes it to travel laterally in the opposite direction as it was previously travelling.

FIG. 7C shows the lure traveling laterally on its left side. The lure will continue to travel laterally on its left side until twitched or until the retrieve stops.

FIG. 7D shows the lure inverting from the left side to the right side.

FIG. 7E shows the lure as it lands after being twitched.

FIG. 7F shows the lure traveling laterally on its right side. The lure will continue to travel laterally on its right side until the lure is twitched or the retrieve is stopped.

FIG. 7G shows the location of the angler/point of retrieval.

FIG. 8A shows the lure traveling on its right side. It will continue to travel this direction until twitched.

FIG. 8B shows the lure traveling on its right side prior to being twitched

FIG. 8C shows the lure at the beginning of being twitched. In this view the lure has overcome the force of the water and has begun to turn upwards, pivoting on the bottom of the lure.

FIG. 8D shows the lure as it is in the middle of being twitched. In this view the lure is currently oriented vertically and is in the process of turning over. At this moment the lure is exactly halfway through being twitched.

FIG. 8E shows the lure as it is falling towards the water after being twitched. As the lure lands on the surface of the water it will land on its left side causing it to start to travel laterally on its left side.

FIG. 8F shows the lure after it has landed on the surface of the water and is starting to travel on its left side.

FIG. 8G shows the lure traveling on its left side. It will continue to travel this direction until twitched.

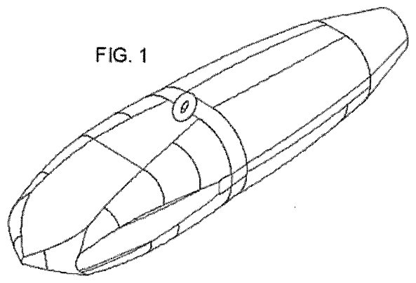

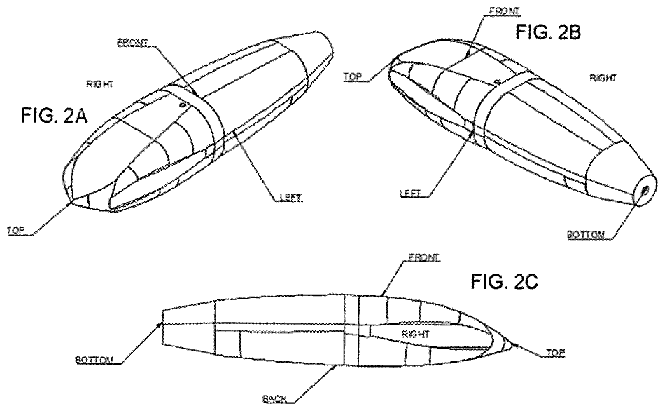

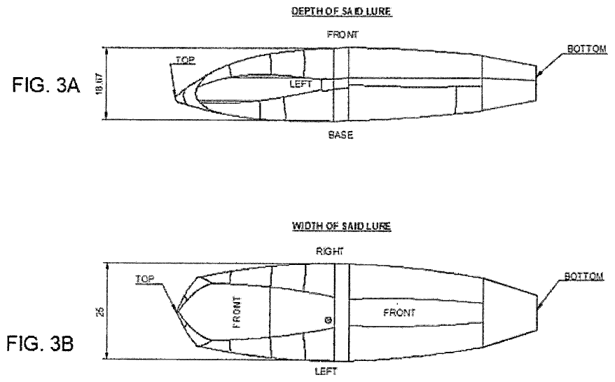

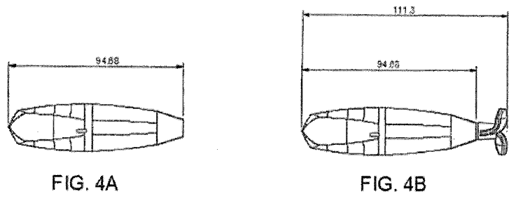

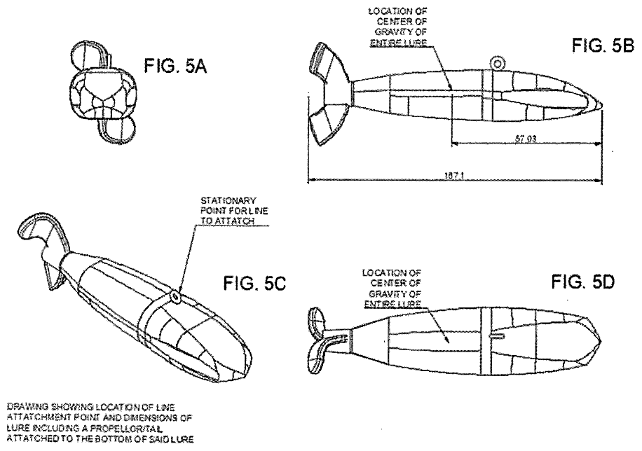

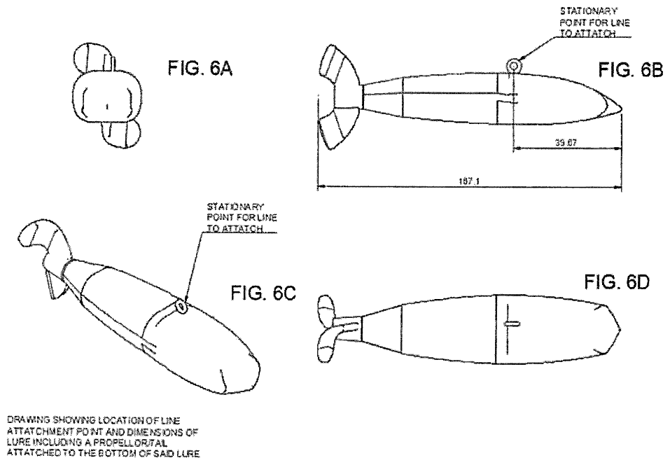

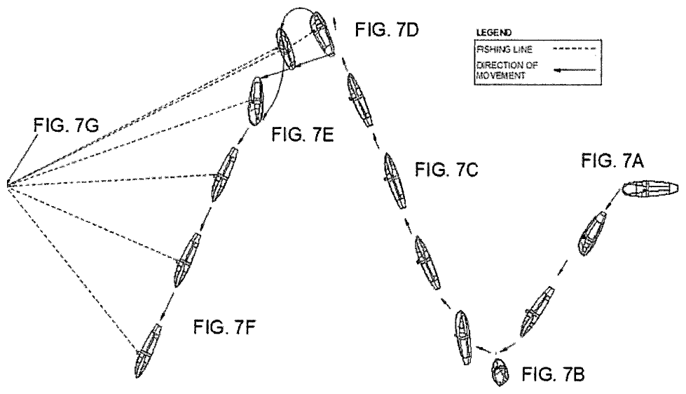

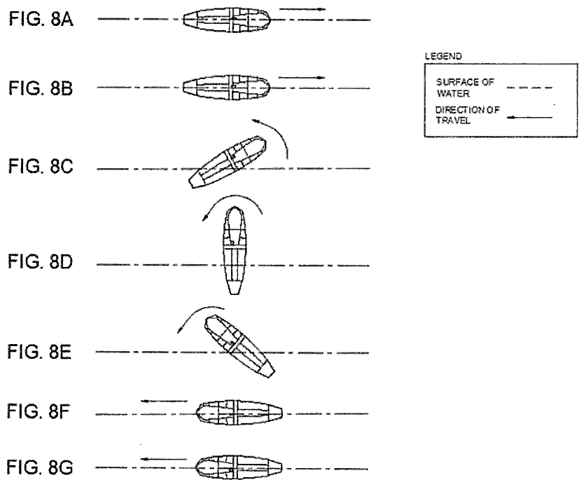

1. A fishing lure comprising of:
a buoyant body;
a frontal plane which is greater in width than the depth of the body;
a stationary point for a fishing line to attach to the frontal plane located between ⅙^{th} and ½ of the total length of the lure from the top of the bait;
a center of gravity of the entire lure located between ⅓ and ¾^{th} of the total length of the lure from the top of the bait;
a propellor/tail/blade attached to the body.

2. The fishing lure of claim 1 wherein a hook and/or hooks are attached to the body.

3. The fishing lure of claim 1 wherein the line attachment point is offset from left to right.

4. The fishing lure of claim 1 wherein the top of the body features a taper to a point which is offset towards the back of the body and not in line with the center line of the body.

5. The fishing lure of claim 1 wherein the body is symmetrical from left to right and asymmetrical from front to back.

6. The fishing lure of claim 1 wherein the body features a moving weight which resides between ⅓ and ¾^{th} of the total length of the lure from the top of the bait for the majority of the retrieval.

7. A fishing lure comprising of:
a buoyant body;
a frontal plane which is greater in width than the depth of the body;
a stationary point for a fishing line to attach to the frontal plane located between 2/9 and 4/9 of the total length of the lure from the top of the bait;
a center of gravity of the entire lure located between ⅖^{th} and ⅗^{th} of the total length of the lure from the top of the bait;
a propellor/tail/blade attached to the body.

8. The fishing lure of claim 7 wherein a hook and/or hooks are attached to the body.

9. The fishing lure of claim 7 wherein the line attachment point is offset from left to right.

10. The fishing lure of claim 7 wherein the top of the body features a taper to a point which is offset towards the back of the body and not in line with the center line of the body.

11. The fishing lure of claim 7 wherein the body is symmetrical from left to right and asymmetrical from front to back.

12. The fishing lure of claim 1 wherein the body features a moving weight which resides between ⅖^{th} and ⅗^{th} of the total length of the lure from the top of the bait for the majority of the retrieval.

13. A fishing lure comprising of:
a buoyant body;
a frontal plane which is greater in width than the depth of the body;
a stationary point for a fishing line to attach to the frontal plane located between 2/9 and 4/9 of the total length of the lure from the top of the bait;
a center of gravity of the entire lure located between ⅖^{th} and ⅗^{th} of the total length of the lure from the top of the bait;
a propellor/tail/blade attached to the bottom of the body.

14. The fishing lure of claim 13 wherein a hook and/or hooks are attached to the body.

15. The fishing lure of claim 13 wherein the line attachment point is offset from left to right.

16. The fishing lure of claim 13 wherein the top of the body features a taper to a point which is offset towards the back of the body and not in line with the center line of the body.

17. The fishing lure of claim 13 wherein the body is symmetrical from left to right and asymmetrical from front to back.

18. The fishing lure of claim 1 wherein the body features a moving weight which resides between ⅖^{th} and ⅗^{th} of the total length of the lure from the top of the bait for the majority of the retrieval.
